(19) United States
(12) Patent Application Publication
(10) Pub. No.: US 2025/0095227 A1
(43) Pub. Date: Mar. 20, 2025

(54) TEXT-GUIDED VECTOR IMAGE SYNTHESIS

(71) Applicant: ADOBE INC., SAN JOSE, CA (US)

(72) Inventors: Adrian-Stefan Ungureanu-Contes, Bucuresti (RO); Marian Lupascu, Bucuresti (RO); Vlad-Constantin Lungu-Stan, Bucuresti (RO); Ionuţ Mironica, Bucharest (RO); Vineet Batra, Delhi (IN)

(21) Appl. No.: 18/886,452

(22) Filed: Sep. 16, 2024

Related U.S. Application Data
(60) Provisional application No. 63/583,380, filed on Sep. 18, 2023.

(30) Foreign Application Priority Data
Sep. 15, 2023 (RO) A/00507/2023

(51) Int. Cl. G06T 11/00; G06T 3/4053

(52) U.S. Cl. CPC G06T 11/00; G06T 3/4053; G06T 2210/36

(57) ABSTRACT

A method, apparatus, non-transitory computer readable medium, and system for training a text-guided vector image synthesis include obtaining training data including a vectorizable image and a caption describing the vectorizable image and generating, using an image generation model, a predicted image with a first level of high frequency detail. Then, the training data and the predicted image are used to tune the image generation model to generate a synthetic vectorizable image based on the caption, where the synthetic vectorizable image has a second level of high frequency detail that is lower than the first level of high frequency detail of the predicted image.

### CROSS-REFERENCE TO RELATED APPLICATIONS

This U.S. non-provisional application claims priority under 35 U.S.C. § 119 to U.S. Provisional Patent Application No. 63/583,380 filed on Sep. 18, 2023 in the United States Patent and Trademark Office, as well as to Romanian Patent Application A/00507/2023 filed in the State Office for Inventions and Trademarks (OSIM) on Sep. 15, 2023, the disclosures of which are incorporated by reference herein in their entirety.

### BACKGROUND

The following relates generally to image processing, and more specifically to image generation. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image processing techniques are also used for image generation. For example, machine learning (ML) techniques have been applied to create generative models that can produce new image content. One use for generative AI is to create images based on an input prompt. This task is often referred to as a “text to image” task or simply “text2img”. Some models such as GANs and Variational Autoencoders (VAEs) employ an encoder-decoder architecture with attention mechanisms to align various parts of text with image features. Newer approaches such as denoising diffusion probabilistic models (DDPMs) iteratively refine generated images in response to textual prompts. These models are typically used to produce images in the form of pixel data, which represents images as a matrix of pixels, where each pixel includes color information.

### SUMMARY

Embodiments of the present inventive concepts include systems and methods for text-guided vector image synthesis. Embodiments include an image generation model that is trained to generate images that are “vectorizable.” The term “vectorizable,” as used herein, describes attributes of an image that enables it to be efficiently and accurately translated from pixel data to vector image format. Characteristics of vectorizable images may include, but are not limited to, flat or solid color regions, clearly defined shapes or boundaries, and the absence of gradient transitions or fuzzy edges. Conversely, non-vectorizable images, characterized by complex textures, gradients, or undefined boundaries, are prone to generating excessive paths during the vectorization process. Some embodiments further include a vectorization component configured to convert the generated vectorizable image into a vector format image.

A method, apparatus, non-transitory computer readable medium, and system for image generation are described. One or more aspects of the method, apparatus, non-transitory computer readable medium, and system include obtaining a text prompt describing an image element; generating, using an image generation model, a vectorizable image based on the text prompt, wherein the image generation model is trained to reduce high-frequency details; and generating a vector image based on the vectorizable image, wherein the vector image includes the image element described by the text prompt.

A method, apparatus, non-transitory computer readable medium, and system for image generation are described. One or more aspects of the method, apparatus, non-transitory computer readable medium, and system include obtaining training data including a vectorizable image and a caption describing the vectorizable image; generating, using an image generation model, a predicted image with a first level of high frequency detail; and tuning, using the training data and the predicted image, the image generation model to generate a synthetic vectorizable image based on the caption, wherein the synthetic vectorizable image has a second level of high frequency detail that is lower than the first level of high frequency detail of the predicted image.

An apparatus, system, and method for image generation are described. One or more aspects of the apparatus, system, and method include at least one processor; at least one memory storing instructions executable by the at least one processor; and an image generation model comprising parameters stored in the at least one memory, wherein the image generation model is trained to generate vectorizable images with reduced high-frequency detail using a training set comprising a vectorizable image.

### BRIEF DESCRIPTION OF THE DRAWINGS

FIG. 1 shows an example of an image generation system according to aspects of the present disclosure.

FIG. 2 shows an example of a vector image generation apparatus according to aspects of the present disclosure.

FIG. 3 shows an example of a guided latent diffusion model according to aspects of the present disclosure.

FIG. 4 shows an example of a U-Net according to aspects of the present disclosure.

FIG. 5 shows an example of a pipeline for generating vector images according to aspects of the present disclosure.

FIG. 6 shows an example of generated images with diffusion prior and without diffusion prior according to aspects of the present disclosure.

FIG. 7 shows an example of upsampled image using traditional upsampling model and an upsampled image using an upsampling model according to the present embodiments according to aspects of the present disclosure.

FIG. 8 shows an example of training data sorted by aesthetic parameter according to aspects of the present disclosure.

FIG. 9 shows an example of a diffusion process according to aspects of the present disclosure.

FIG. 10 shows an example of a method for generating a vector image from a text prompt according to aspects of the present disclosure.

FIG. 11 shows an example of a machine learning model training algorithm according to aspects of the present disclosure.

FIG. 12 shows an example of a method for training a diffusion model according to aspects of the present disclosure.

FIG. 13 shows an example of a pipeline for training an image generation apparatus according to aspects of the present disclosure.

FIG. 14 shows an example of a method for tuning an image generation model to generate synthetic vectorizable images according to aspects of the present disclosure.

FIG. 15 shows an example of a computing device according to aspects of the present disclosure.

### DETAILED DESCRIPTION

Image generation is frequently used in creative workflows. Historically, users would rely on manual techniques and drawing software to create visual content. The advent of machine learning (ML) has enabled new workflows that automate the image creation process. ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Generative models in ML are algorithms designed to generate new data samples that resemble a given dataset. Generative models are used in various fields, including image generation. They work by learning patterns, features, and distributions from a dataset and then using this understanding to produce new, original outputs.

Users may prefer to work with vector image formats in some cases. The image format refers to a type of digital graphic representation that utilizes mathematical equations to define paths and shapes, rather than mapping individual pixels. This format enables scalable and resolution-independent rendering of the image elements. It further allows for precise manipulation of image attributes such as colors, shapes, and outlines without degradation in quality, making it a preferred format for logos and illustrations.

Some approaches for generating vector images involve the use of machine learning techniques. These methods typically employ neural network architectures trained on large datasets of vector graphics and associated textual descriptions. Such approaches aim to create vector images based on user-provided text prompts or descriptions, automating the process of translating textual concepts into visual representations.

Some conventional approaches for vector image generation focus on directly generating vector graphics elements, such as paths and shapes, based on learned representations of text and visual concepts. While these techniques have shown promise in generating vector graphics like icons and simple illustrations, they often struggle with more complex or diverse types of vector documents. For example, the techniques may be limited in their output domains, to a particular type of document such as logos. Additionally, the quality and flexibility of the generated output may not meet the standards required for professional use across various categories of vector graphics, such as detailed scenes, characters, or infographics.

Embodiments improve the efficiency of vector image generation systems by generating easily vectorizable images. Vectorizable images are images that have attributes that enable the image to be efficiently and accurately translated from pixel data to vector image format. Such attributes include, but are not limited to, flat or solid color regions, clearly defined shapes or boundaries, and the absence of gradient transitions or fuzzy edges. This results in vector formatted images that have reduced file size and increased editability.

Embodiments include an image generation model that is trained to generate a vectorizable image, and a vectorization component that converts the vectorizable image to a vector image. According to some aspects, the image generation model includes a diffusion prior model, a diffusion model, and an upsampling model. A training process configures the diffusion prior model to generate a prior vector, sometimes referred to as a prior embedding, which is used to condition the generation process of the diffusion model. In some embodiments, the diffusion prior model is trained to generate embeddings that condition the diffusion model to generate vectorizable images. For example, the diffusion prior model may be trained on training data that includes highly vectorizable images. Therefore, when given a text prompt, the diffusion prior model generates image embeddings in a multimodal space (e.g., a text-image embedding space such as a CLIP space), such that the image embeddings represent vectorizable characteristics that are transferred to the diffusion model during generation.

An upsampling model is used in some embodiments to further process the output of the diffusion model. For example, the upsampling model may include a generative adversarial network (GAN) based upsampler that is configured to increase the resolution of the diffusion model output. In some embodiments, the GAN is replaced by a variational auto-encoder (VAE) decoder model or augmented by a VAE decoder. The upsampling model may be trained to further enhance vectorizable characteristics or to remove non-vectorizable characteristics during the upsampling process. In some cases, the upsampling model is trained on a dataset including vectorizable images such as patterns, icons, and graphics, as contrasted with non-vectorizable images such as photorealistic images.

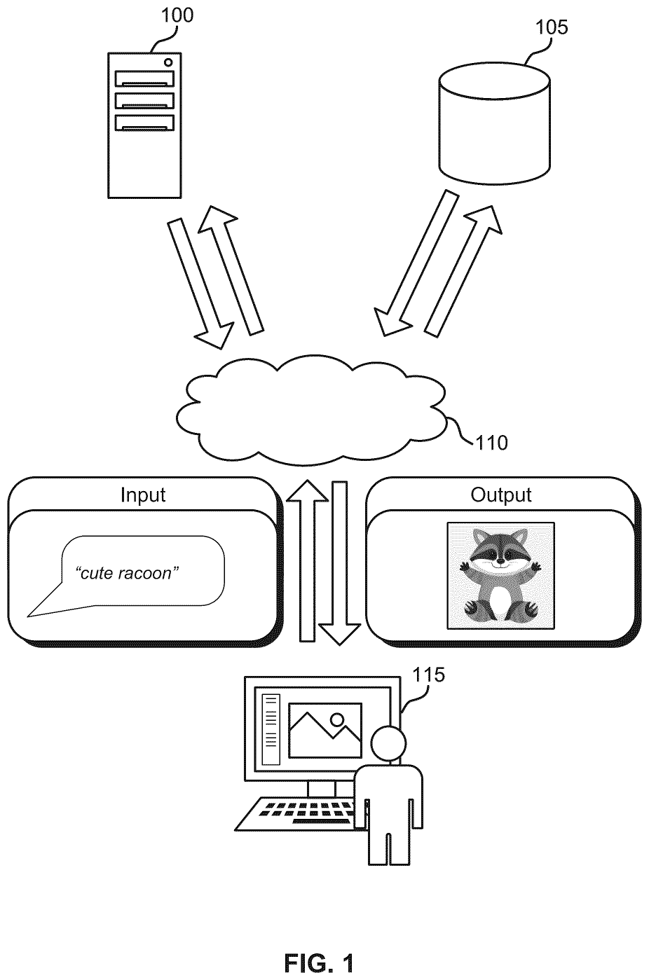

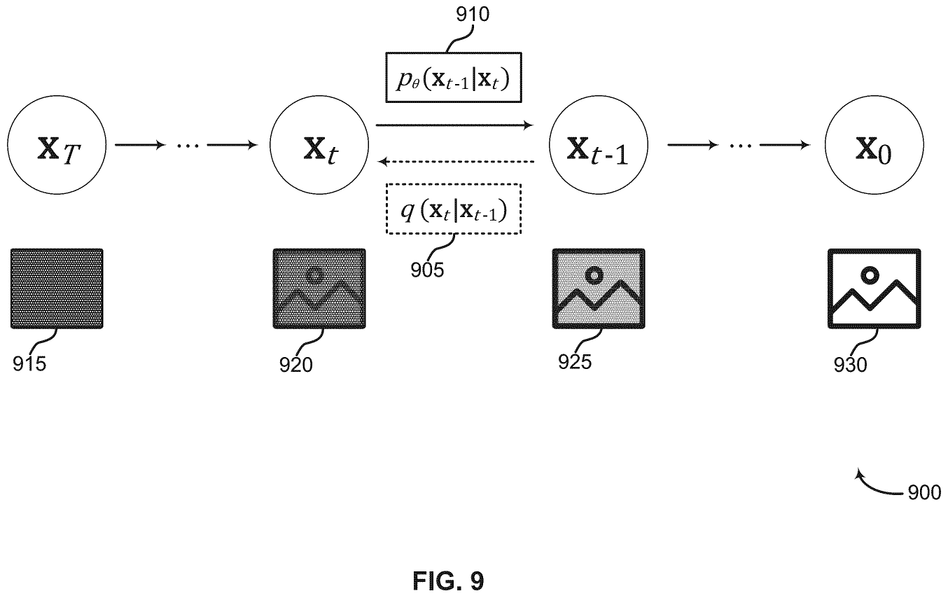

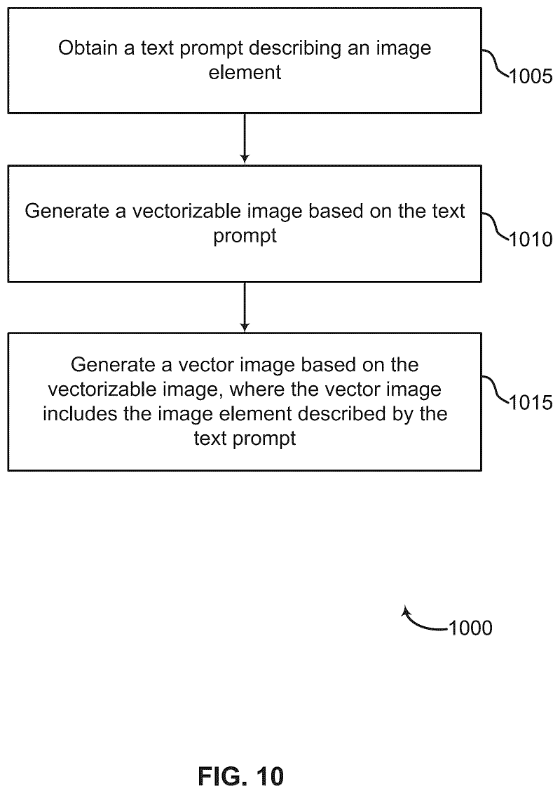

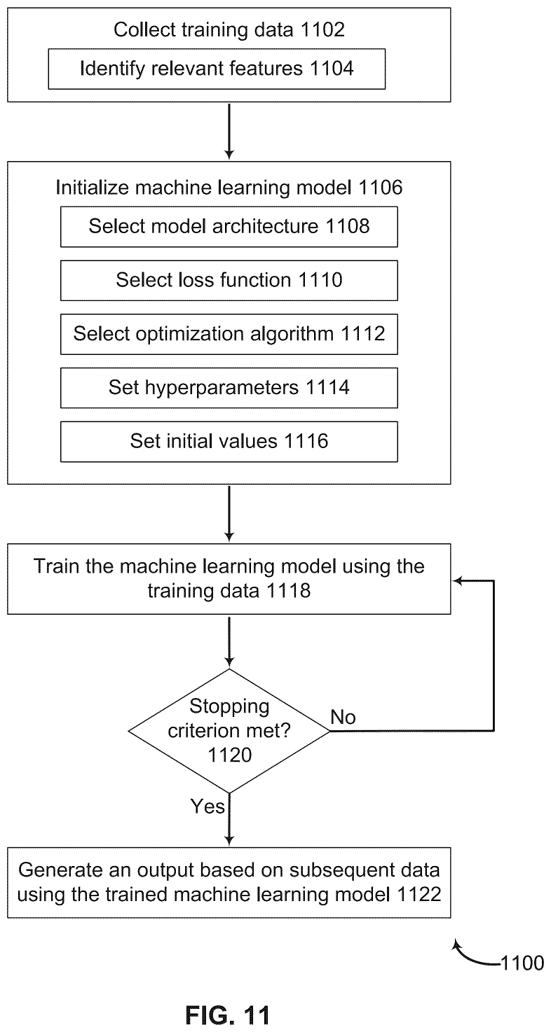

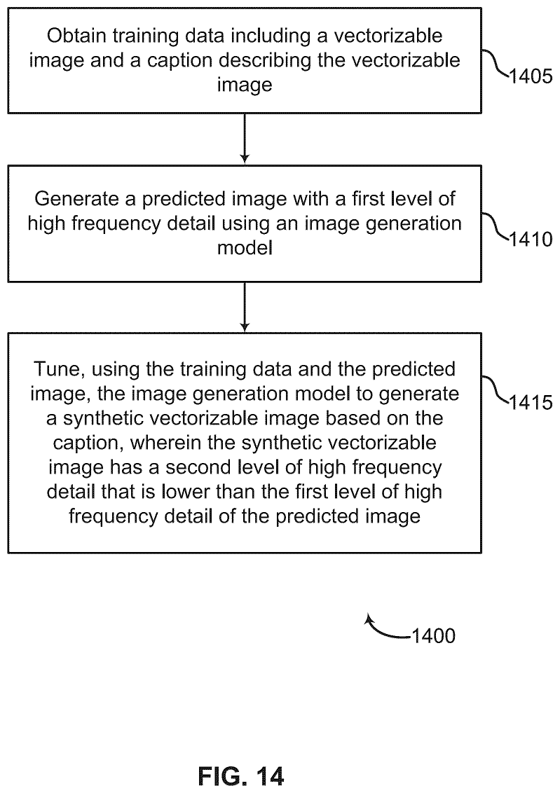

An image generation system is described with reference to FIGS. 1-8. Methods for generating a vector image from text are described with reference to FIGS. 9-10. Methods for training machine learning models are described with reference to FIGS. 11-13. A computing device which can implement a vector image generation apparatus is described with reference to FIG. 14.

### Image Generation System

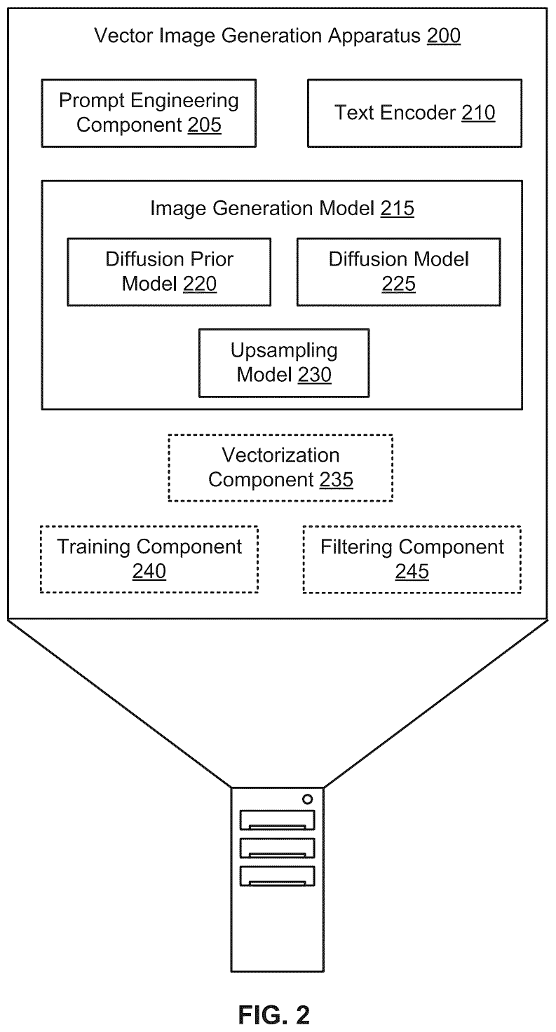

FIG. 1 shows an example of an image generation system according to aspects of the present disclosure. The example shown includes vector image generation apparatus 100, database 105, network 110, and user interface 115. Vector image generation apparatus 100 is an example of, or includes aspects of, the corresponding element described with reference to FIG. 2.

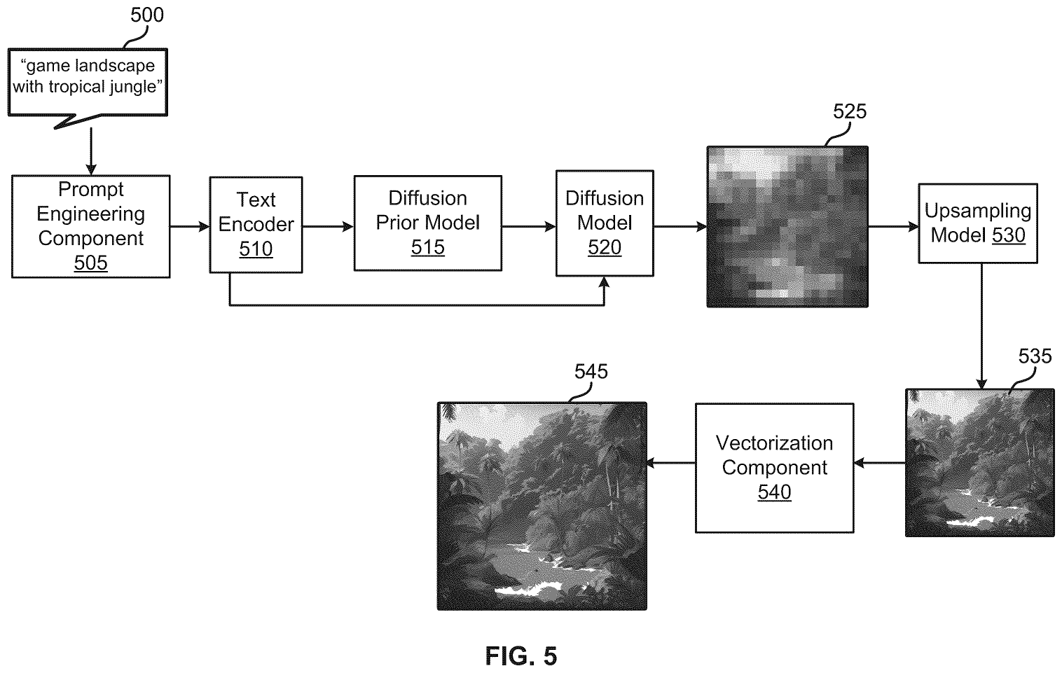

In an example, a user provides a text prompt such as “cute raccoon” to vector image generation apparatus 100 via user interface 115. The vector image generation apparatus 100 then processes the text prompt to generate a vector image that depicts one or more elements from the text prompt. A vector image refers to a type of digital graphic representation that utilizes mathematical equations to define paths and shapes, rather than mapping individual pixels. Then, vector image generation apparatus 100 sends the vector image over network 110 back to the user. A pipeline for the generation process is described with reference to FIG. 5.

In some cases, one or more components of vector image generation apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the vector image generation system. For example, database 105 may store previously generated images, machine learning model parameters, training data, and the like. A database is an organized collection of data. For example, a database stores data in a specified format known as a schema. A database may be structured as a single database, a distributed database, multiple distributed databases, or an emergency backup database. In some cases, a database controller may manage data storage and processing in the database. In some cases, a user interacts with the database controller. In other cases, the database controller may operate automatically without user interaction.

Network 110 is configured to facilitate the transfer of information between vector image generation apparatus 100, database 105, and user interface 115. In some cases, network 100 is referred to as a “cloud”. A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

User interface 115 enables a user to interact with the vector image generation system. In some embodiments, the user interface 115 may include an audio device, such as an external speaker system, an external display device such as a display screen, or an input device (e.g., remote control device interfaced with the user interface 115 directly or through an IO controller module). In some cases, a user interface 115 may be a graphical user interface (GUI). For example, the GUI may be incorporated as part of a web application.

FIG. 2 shows an example of a vector image generation apparatus 200 according to aspects of the present disclosure. The example shown includes vector image generation apparatus 200, prompt engineering component 205, text encoder 210, image generation model 215, vectorization component 235, training component 240, and filtering component 245.

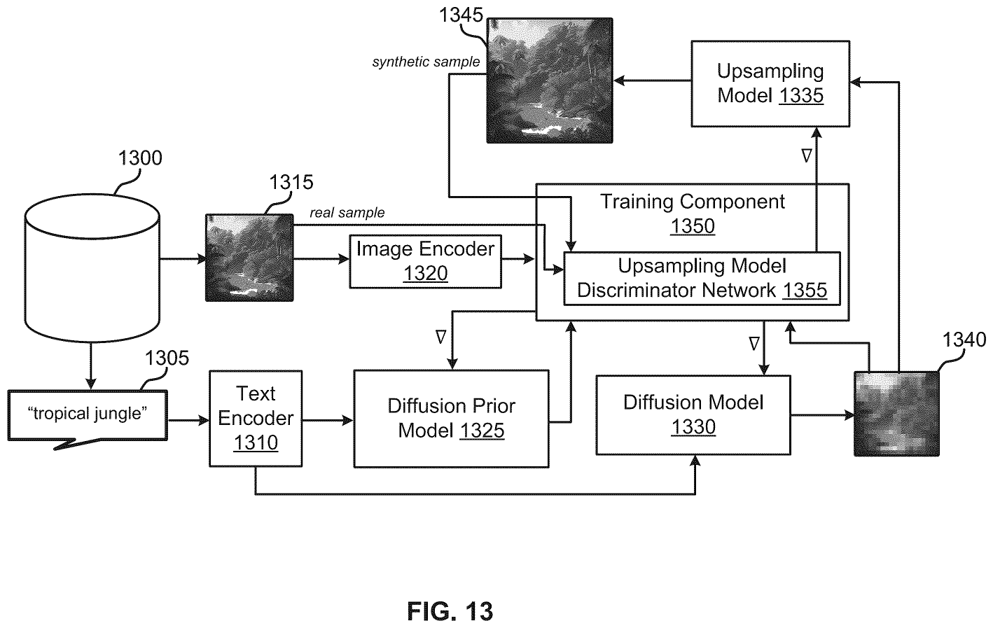

Vector image generation apparatus 200 is an example of, or includes aspects of, the corresponding element described with reference to FIG. 1. Prompt engineering component 205 is an example of, or includes aspects of, the corresponding element described with reference to FIG. 5. Text encoder 210 is an example of, or includes aspects of, the corresponding element described with reference to FIGS. 5 and 13.

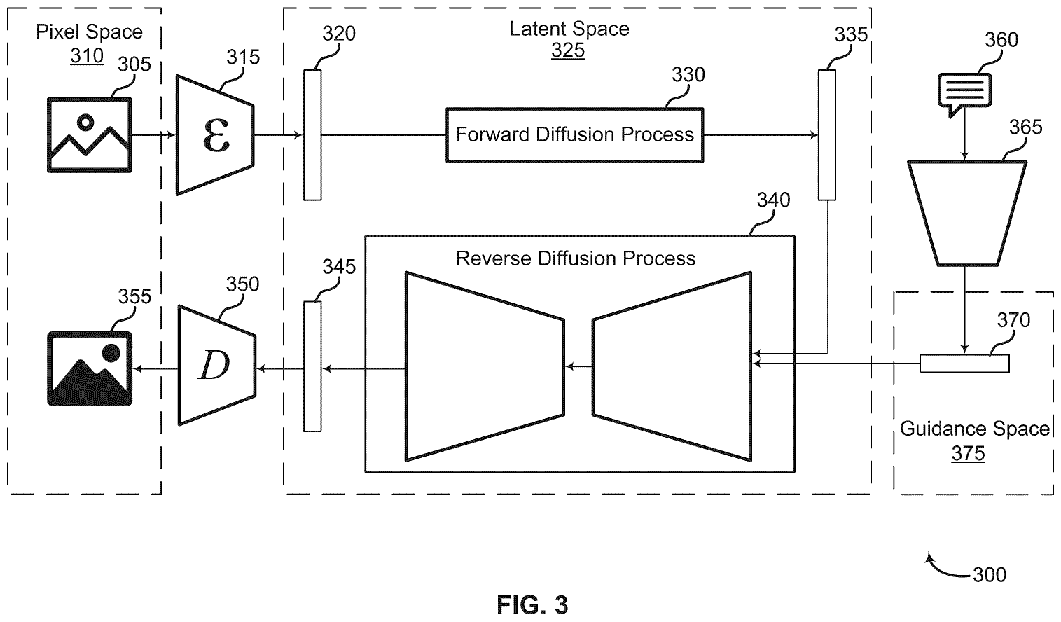

Diffusion model 225 is an example of, or includes aspects of, the corresponding element described with reference to FIGS. 3, 5 and 13. Upsampling model 230 is an example of, or includes aspects of, the corresponding element described with reference to FIGS. 5 and 13. Vectorization component 235 is an example of, or includes aspects of, the corresponding element described with reference to FIG. 5. Training component 240 is an example of, or includes aspects of, the corresponding element described with reference to FIG. 13.

Embodiments of vector image generation apparatus 200 include several components and sub-components. These components are variously named and are described so as to partition the functionality enabled by the processor(s) and the executable instructions included in the computing device used to implement vector image generation apparatus 200 (such as the computing device described with reference to FIG. 14). The partitions may be implemented physically, such as through the use of separate circuits or processors for each component or may be implemented logically via the architecture of the code executable by the processors.

Components of vector image generation apparatus 200, such as text encoder 210 and image generation model 215, may include one or more artificial neural network sub-components. An artificial neural network (ANN) is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

Prompt engineering component 205 is configured to adjust a user prompt before it is processed by other components, e.g., text encoder 210. According to some aspects, prompt engineering component 205 adds a class category to the text prompt. Examples of class categories include “minimal”, “logo”, scene “, object”, “pattern”, and “character”. The category may be determined via a language model which processes the prompt or selected by a user through a user interface via, e.g., a dropdown menu. In some cases, performing the prompt engineering increases the degree of detail in images, increases the diversity of generated images, and increases the alignment of the generated vectorizable image with the intention of the user. One example of a prompt engineering scheme used by prompt engineering component 205 is provided in the following table:

TABLE 1
Example prompt engineering scheme

| Image class category | Prompt Engineering scheme |
|---|---|
| minimal | prompt + “minimalist, hard strokes, low |
| | on details, simple colors” |
| logo | prompt + “no text, logo, sharp, bold, |
| | inspirational, commercial, no text” |
| scene | prompt + “full scene, picturesque, |
| | detailed background, natural scene” |
| object | prompt + “single object, sole instance, |
| | only one” |
| pattern | prompt + “pattern, texture, repeated, |
| | tiled” |
| character | “cartoon character of a” + prompt |

Text encoder 210 is configured to generate a text embedding, which a data-rich vector representation of text designed to capture semantic meaning. Embodiments of text encoder 210 include a transformer-based model, such as FLAN-T5. A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes an attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

In one aspect, image generation model 215 includes diffusion prior model 220, diffusion model 225, and upsampling model 230. According to some aspects, image generation model 215 generates, using an image generation model 215, a vectorizable image based on the text prompt, where the image generation model 215 is trained to reduce high-frequency details. In at least one embodiment, the image generation model omits the upsampling model 230.

Diffusion prior model 220 is configured to process the text embedding produced by text encoder 210 to generate a prior embedding. The prior embedding is used to condition the image generation performed by diffusion model 225. In some cases, the diffusion prior model 220 generates a prior embedding in a multimodal embedding space, such as a CLIP space.

Contrastive Language-Image Pre-Training (CLIP) is a neural network that is trained to efficiently learn visual concepts from natural language supervision. CLIP can be instructed in natural language to perform a variety of classification benchmarks without directly optimizing for the benchmarks' performance, in a manner building on “zero-shot” or zero-data learning. CLIP can learn from unfiltered, highly varied, and highly noisy data, such as text paired with images found across the Internet, in a similar but more efficient manner to zero-shot learning, thus reducing the need for expensive and large labeled datasets. A CLIP model can be applied to nearly arbitrary visual classification tasks so that the model may predict the likelihood of a text description being paired with a particular image, removing the need for users to design their own classifiers and the need for task-specific training data. For example, a CLIP model can be applied to a new task by inputting names of the task's visual concepts to the model's text encoder. The model can then output a linear classifier of CLIP's visual representations. The embedding space in which a CLIP model encodes both image inputs and text inputs is referred to as a CLIP space.

Upsampling model 230 is configured to upsample the output from diffusion model 225. According to some aspects, upsampling model 230 includes a generative adversarial network (GAN) based upsampling model. GANs are a class of artificial intelligence algorithms utilized in unsupervised machine learning, encompassing two interconnected networks: a generator, tasked with the creation of data, and a discriminator, responsible for distinguishing between genuine and generated data. The discriminator is used during the training process and is usually discarded once the network is trained. In the context of image generation and particularly in the enhancement of output resolution in DDPM-generated images, GAN-based upsamplers function to augment the resolution of images produced by diffusion models, thereby amplifying the detail and sharpness of the synthesized images.

GAN-based upsamplers may be used to increase the resolution of the output from a DDPM (Denoising Diffusion Probabilistic Model) such as diffusion model 225. In some cases, DDPMs face resolution constraints due to the computational and memory demands inherent to the diffusion process. However, through the initial generation of images at a subdued resolution and the subsequent application of GAN-based upsamplers to heighten the resolution, it becomes feasible to obtain outputs of superior resolution without a substantial compromise on image quality.

GAN-based upsamplers are trained during a process that configures them to map lower-resolution images to higher-resolution equivalents utilizing a training dataset comprised of paired low and high-resolution images. Specifically, the generator in the GAN learns to fabricate higher-resolution images that the discriminator cannot differentiate from authentic high-resolution counterparts.

Embodiments of upsampling model 230 are trained in a training process that fine-tunes an existing upsampling network by training on vectorizable training images, characterized by attributes such as flat or solid color regions and clearly defined shapes or boundaries. This training process configures upsampling model 230 to perform an upsampling process that not only increases the resolution of an image but also to retain vectorizable attributes and remove non-vectorizable attributes.

Vectorization component 235 is configured to translate pixel data produced by image generation model 215 to a vector image, i.e., an image in a vector graphics format. Vectorization entails the conversion of pixel data found in raster images to vector graphics data. Initially, the pixel data, which is characterized by grid cells or pixels each holding distinct color information, is subjected to a feature analysis. During this phase, the attributes of the image, including edges, shapes, and color regions are identified and isolated using various algorithms capable of detecting distinct boundaries and shapes within the pixel data.

In some aspects, the identified elements are then transformed into mathematical representations that depict geometric shapes and paths defined by parameters such as strokes, fills, and gradients. This transformation utilizes techniques like noise reduction and curve smoothing, which facilitate the creation of clear and defined paths constituted by a series of points, lines, and curves. These paths form the vector graphics data, allowing for the scalable reconstruction of the image without loss of quality. These methods ensures that the final vector graphics are not only scalable but also maintain a high degree of fidelity to the original raster image, thereby making them suitable for further editing and manipulation in various applications.

When this process is applied to non-vectorizable images, several complications may arise. For instance, images characterized by blurry elements, numerous colors, or non-distinct lines and shapes can result in a vector representation that possesses a high level of complexity and an excessive number of paths, thereby leading to larger file sizes and reduced editability. For example, colors may not be easily changed during editing, as shapes bleed into others and are not distinctly bound.

Accordingly, embodiments are configured to generate vector images that are highly editable and with reduced artifacts. According to some aspects, the diffusion prior model enables the image generation model to generate many different classes of vector images, and to disentangle the classes in a diffusion prior embedding space. The disentanglement allows the generation of diffusion priors that in turn enable the generation of vectorizable images with increased diversity and alignment with a user prompt.

In at least one embodiment, vectorization component 235, training component 240, filtering component 245, or a combination thereof, are implemented on an apparatus different from vector image generation apparatus 200.

Training component 240 is configured to update image generation model 215 by adjusting parameters thereof according to one or more losses. In some aspects, the losses are computed based on a comparison between content generated by image generation model 215 and ground-truth images from training data.

According to some aspects, training component 240 trains an image generation model 215 to generate images with reduced high-frequency detail based on the training data. In some examples, training component 240 tunes the pre-trained image generation model 215 based on the training data. In some examples, training component 240 trains a diffusion prior model 220 based on the training data. In some examples, training component 235 trains a diffusion model 225 based on the training data. In some examples, training component 235 trains an upsampling model 230 based on the training data.

In some examples, training component 240 obtains training data including a vectorizable image and a caption describing the vectorizable image. The image generation model generates a predicted image with a first level of high frequency detail and training component 240 tunes the image generation model using the training data and the predicted image. In some cases, training component 240 trains the image generation model to generate a synthetic vectorizable image based on the caption, where the synthetic vectorizable image has a second level of high frequency detail that is lower than the first level of high frequency detail of the predicted image.

Filtering component 245 is configured to obtain training data from a set of images through one or more filtering operations. In some embodiments, filtering component 245 filters a set of images by removing images that include texts. In some cases, filtering component 245 removes images that include rasterization errors. For example, some images may have had an alpha or transparency channel before conversion, and artifact of this channel may be shown by a checkerboard background in the image.

Some embodiments of filtering component 245 perform a background color detection, and then convert any non-white backgrounds to white. The background color detection process may include performing a palette extraction algorithm to identify a dominant color and removing the dominant color. Some embodiments of filtering component 245 further include identifying one or more regions corresponding to icons in a training image, and then generating training additional training images by extracting one or more additional images from the one or more regions, respectively. Some embodiments of filtering component 245 identify the regions based on a lower-bound and upper-bound size, filtering out regions that are smaller than the lower-bound or larger than the upper-bound. Embodiments are further configured to compute an aesthetic parameter for each image in the set of images, and to remove images that are below a threshold value for the aesthetic parameter. For example, embodiments of filtering component 245 include an aesthetic classifier ANN such as a LAION aesthetic classifier. In one example, filtering component 245 selects the top x % images according to the computed aesthetic parameter as the training data, though embodiments are not necessarily limited thereto. In one example, x is 25.

FIG. 3 shows an example of a guided latent diffusion model according to aspects of the present disclosure. The guided latent diffusion model 300 depicted in FIG. 3 is an example of, or includes aspects of, the diffusion prior model 220 and the diffusion model 225 described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 300 may take an original image 305 in a pixel space 310 as input and apply and image encoder 315 to convert original image 305 into original image features 320 in a latent space 325. Then, a forward diffusion process 330 gradually adds noise to the original image features 320 to obtain noisy features 335 (also in latent space 325) at various noise levels.

Next, a reverse diffusion process 340 (e.g., a U-Net ANN) gradually removes the noise from the noisy features 335 at the various noise levels to obtain denoised image features 345 in latent space 325. In some examples, the denoised image features 345 are compared to the original image features 320 at each of the various noise levels, and parameters of the reverse diffusion process 340 of the diffusion model are updated based on the comparison. Finally, an image decoder 350 decodes the denoised image features 345 to obtain an output image 355 in pixel space 310. In some cases, an output image 355 is created at each of the various noise levels. The output image 355 can be compared to the original image 305 to train the reverse diffusion process 340.

In some cases, image encoder 315 and image decoder 350 are pre-trained prior to training the reverse diffusion process 340. In some examples, they are trained jointly, or the image encoder 315 and image decoder 350 and fine-tuned jointly with the reverse diffusion process 340.

The reverse diffusion process 340 can also be guided based on a text prompt 360, or another guidance prompt, such as an image, a layout, a segmentation map, etc. The text prompt 360 can be encoded using a text encoder 365 (e.g., a multimodal encoder) to obtain guidance features 370 in guidance space 375. The guidance features 370 can be combined with the noisy features 335 at one or more layers of the reverse diffusion process 340 to ensure that the output image 355 includes content described by the text prompt 360. For example, guidance features 370 can be combined with the noisy features 335 using a cross-attention block within the reverse diffusion process 340.

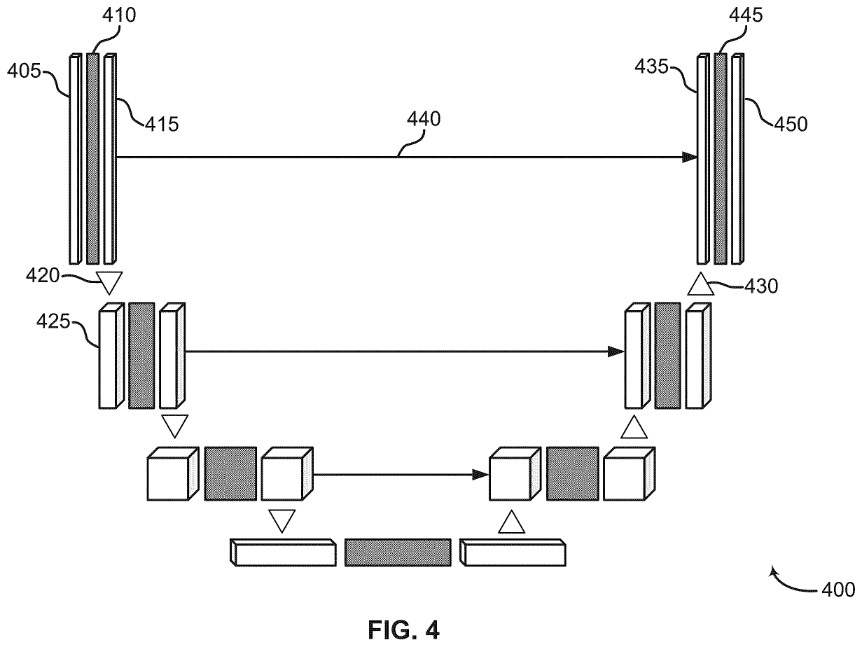

FIG. 4 shows an example of a U-Net 400 according to aspects of the present disclosure. In some examples, U-Net 400 is an example of the component that performs the reverse diffusion process 340 of guided diffusion model 300 described with reference to FIG. 3 and includes architectural elements of the diffusion prior model 220 and the diffusion model 225 described with reference to FIG. 2. The U-Net 400 depicted in FIG. 4 is an example of, or includes aspects of, the architecture used within the reverse diffusion process described with reference to FIG. 3.

In some examples, diffusion models are based on a neural network architecture known as a U-Net. The U-Net 400 takes input features 405 having an initial resolution and an initial number of channels and processes the input features 405 using an initial neural network layer 410 (e.g., a convolutional network layer) to produce intermediate features 415. The intermediate features 415 are then down-sampled using a down-sampling layer 420 such that down-sampled features 425 have a resolution less than the initial resolution and a number of channels greater than the initial number of channels.

This process is repeated multiple times, and then the process is reversed. That is, the down-sampled features 425 are up-sampled using up-sampling process 430 to obtain up-sampled features 435. The up-sampled features 435 can be combined with intermediate features 415 having the same resolution and number of channels via a skip connection 440. These inputs are processed using a final neural network layer 445 to produce output features 450. In some cases, the output features 450 have the same resolution as the initial resolution and the same number of channels as the initial number of channels.

In some cases, U-Net 400 takes additional input features to produce conditionally generated output. For example, the additional input features could include a vector representation of an input prompt. The additional input features can be combined with the intermediate features 415 within the neural network at one or more layers. For example, a cross-attention module can be used to combine the additional input features and the intermediate features 415.

FIG. 5 shows an example of a pipeline for generating vector images according to aspects of the present disclosure. The example shown includes text prompt 500, prompt engineering component 505, text encoder 510, diffusion prior model 515, diffusion model 520, generated image 525, upsampling model 530, upsampled image 535, vectorization component 540, and vector formatted image 545.

Prompt engineering component 505 is an example of, or includes aspects of, the corresponding element described with reference to FIG. 2. Text encoder 510, diffusion prior model 515, diffusion model 520, and upsampling model 530 are examples of, or include aspects of, the corresponding elements described with reference to FIGS. 2 and 13. Vectorization component 540 is an example of, or includes aspects of, the corresponding element described with reference to FIG. 2.

In the pipeline shown, the system obtains a text prompt 500 which describes a desired image for generation. In some cases, the system further obtains a class category of image for generation. In this example, prompt engineering 505 alters text prompt 500 to include the class category, before passing the altered prompt to text encoder 510 to produce a text embedding. The text embedding is input to diffusion prior model 515 to generate a prior embedding. For example, the prior embedding may be generated according to the diffusion process as described above.

Then, both the prior embedding and the text embedding are applied to diffusion model 520. Diffusion model 520 generates generated image 525 based on conditioning from the text embedding and the prior embedding. The diffusion model 520 may perform the generation according to the diffusion process described above with reference to FIG. 3. Generated image 525 is applied to upsampling model 530, whereby it is upsampled to a higher resolution to yield upsampled image 535. According to some aspects, though generated image 525 may already be a vectorizable image, upsampling model 530 may further remove other non-vectorizable characteristics such as fuzzy boundaries and may simplify colors and shapes.

Then, upsampled image 535 is applied to vectorization component 540 to generate vector formatted image 545. According to some aspects, vectorization component 540 performs computer vision techniques such as edge and corner detection to transform features from upsampled image 535 into vector-format relationships including shape primitives, paths, stroke fills, and other information.

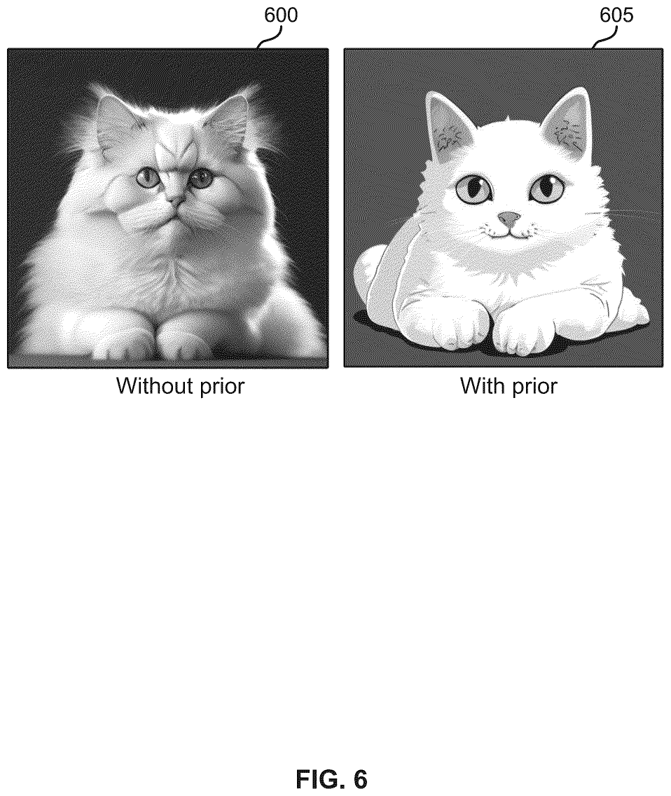

FIG. 6 shows an example of generated images with diffusion prior and without diffusion prior according to aspects of the present disclosure. The example shown includes generated image without diffusion prior 600 and generated image with diffusion prior 605.

A generative model such as a diffusion model may be pre-trained on an image dataset. In some cases, the pre-training involves learning to generate photo-realistic images with lots of high frequency detail, such as detailed textures. In this example, the diffusion model receives a prompt of “a white cat” and generates generated image without diffusion prior 600. As shown in this example, the left image includes many areas with high frequency detail such as detailed fur, as well as blurred areas without clear shapes or boundaries, such as the out of focus areas near the paws. This image is not easily vectorizable, as vectorization algorithms may struggle to identify clear boundaries between shapes, which correspond to vector paths.

By contrast, embodiments include a diffusion prior model configured to generate a prior embedding (also referred to as a “diffusion prior”). A diffusion model may use the diffusion prior as conditioning to generate generated image with diffusion prior 605. This image is a highly vectorizable image, as it includes flat colors, clear shape boundaries, and sharp lines. Accordingly, embodiments are configured to produce images that are more vectorizable than conventional systems which generate without a diffusion prior.

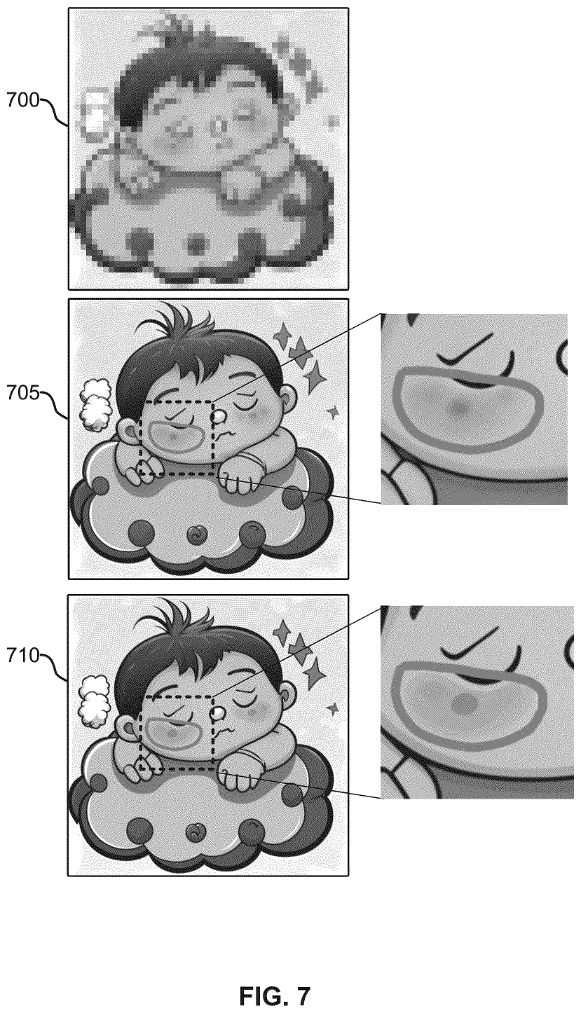

FIG. 7 shows an example of upsampled image using traditional upsampling model and an upsampled image using an upsampling model according to the present embodiments according to aspects of the present disclosure. The example shown includes diffusion model output 700, upsampled image using conventional upsampling model 705, and upsampled image using present upsampling model 710.

In this example, a user may want to increase the resolution of a generated image, such as diffusion model output 700. Accordingly, the system may process diffusion model output 700 using an upsampling network. A conventional upsampling model may generate an upsampled image using conventional upsampling model 705, which, although is a higher resolution, is not fully suitable for vectorization. For example, as indicated by the red circle, the detail on the cartoon face may include color gradients that are not easily separated for representation in a vector image.

In contrast, the upsampling model of the present embodiments may process diffusion model output 700 to generate upsampled image using present upsampling model 710. This image differs from upsampled image using conventional upsampling model 705 in that, among other things, the gradual color gradients on the cartoon face are removed in place of flattened colors. Accordingly, vectorizing the upsampled image using present upsampling model 710 may result in a vector image that has fewer paths, which reduces file size and facilitates later editing processes.

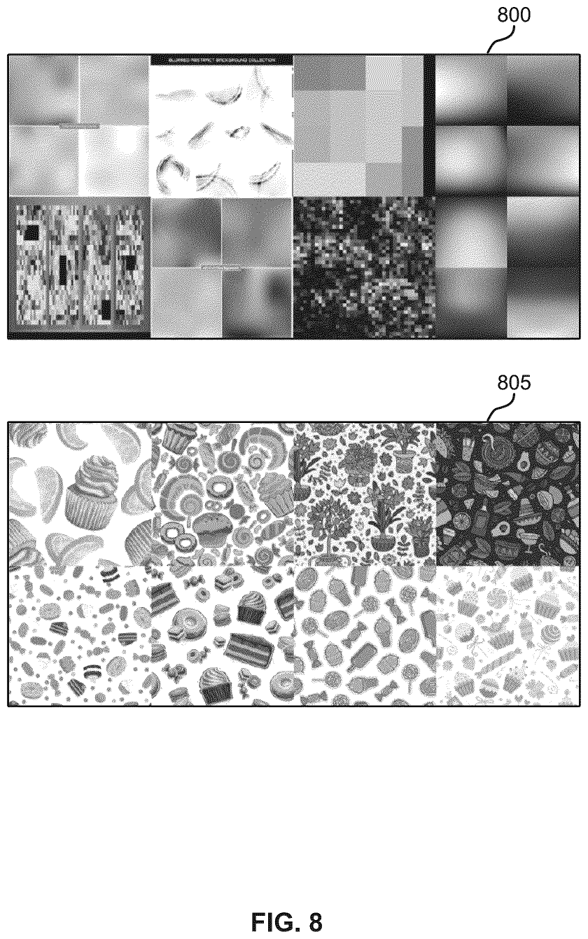

FIG. 8 shows an example of training data sorted by aesthetic parameter according to aspects of the present disclosure. The example shown includes lowest aesthetic score images 800 and highest aesthetic score images 805.

### Generating Vectorizable Images

Embodiments are configured to train an image generation model using training data that is representative of high-quality vectorizable images. In some examples, a filtering component includes an aesthetic classifier ANN. An aesthetic classifier may be trained to generate a high aesthetic score or parameter based on a measure of aesthetic-ness for an image. For example, the aesthetic classifier may be trained on a labeled dataset, where the labels correspond to the aesthetic-ness of an image as reported by other users. According to some aspects, the filtering component evaluates images in a set of images, and orders them according to their aesthetic score. The lowest aesthetic images 800 may include non-vectorizable characteristics, and highest aesthetic images 805 may include vectorizable characteristics. Characteristics of vectorizable images may include, but are not limited to, flat or solid color regions, clearly defined shapes or boundaries, and the absence of gradient transitions or fuzzy edges. Accordingly, in some embodiments, the filtering component selects images with the highest aesthetic scores for use as training data.

FIG. 9 shows a diffusion process 900 according to aspects of the present disclosure. In some examples, diffusion process 900 describes an operation of the diffusion prior model 220 and the diffusion model 225 described with reference to FIG. 2, such as the reverse diffusion process 340 of guided diffusion model 300 described with reference to FIG. 3.

As described above with reference to FIG. 3, using a diffusion model can involve both a forward diffusion process 905 for adding noise to an image (or features in a latent space) and a reverse diffusion process 910 for denoising the images (or features) to obtain a denoised image. The forward diffusion process 905 can be represented as q(xₜ|xₜ₋₁), and the reverse diffusion process 910 can be represented as p(xₜ₋₁|xₜ). In some cases, the forward diffusion process 905 is used during training to generate images with successively greater noise, and a neural network is trained to perform the reverse diffusion process 910 (i.e., to successively remove the noise).

In an example forward process for a latent diffusion model, the model maps an observed variable xo (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as xo.

The neural network may be trained to perform the reverse process. During the reverse diffusion process 910, the model begins with noisy data x_{T}, such as a noisy image 915 and denoises the data to obtain the p(xₜ₋₁|xₜ). At each step t−1, the reverse diffusion process 910 takes xₜ, such as first intermediate image 920, and t as input. Here, t represents a step in the sequence of transitions associated with different noise levels, The reverse diffusion process 910 outputs xₜ₋₁, such as second intermediate image 925 iteratively until x_{T} reverts back to x₀, the original image 930. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0, I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

FIG. 10 shows an example of a method 1000 for generating a vector image from a text prompt according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1005, the system obtains a text prompt describing an image element. In some cases, the operations of this step refer to, or may be performed by, a vector image generation apparatus as described with reference to FIGS. 1 and 2. The system may do so via a user interface such as the one described with reference to FIG. 1. In some examples, the system obtains an image category as well and modifies the text prompt to include the image category. In some examples, the image category is extracted from the text prompt.

At operation 1010, the system generates, using an image generation model, a vectorizable image based on the text prompt, where the image generation model is trained to reduce high-frequency details. In some cases, the operations of this step refer to, or may be performed by, an image generation model as described with reference to FIG. 2. The system may, for example, encode the text prompt using a diffusion prior model to generate a prompt embedding, and then use a diffusion model to generate the vectorizable image, where the generation is conditioned with the prompt embedding. The generation of the prompt embedding and the vectorizable image may be performed through a reverse diffusion process as described with reference to FIGS. 3 and 9.

At operation 1015, the system generates a vector image based on the vectorizable image, where the vector image includes the image element described by the text prompt. In some cases, the operations of this step refer to, or may be performed by, a vectorization component. Additional detail regarding the vectorization component and its operations is provided with reference to FIGS. 2 and 5.

FIG. 11 is a flow diagram depicting an algorithm as a step-by-step procedure 1100 in an example implementation of operations performable for training a machine-learning model. In some embodiments, the procedure 1100 describes an operation of the training component 240 described for configuring the diffusion prior model 220, the diffusion model 225, the upsampling model 230, or a combination thereof as described with reference to FIG. 2. The procedure 1100 provides one or more examples of generating training data, use of the training data to train a machine-learning model, and use of the trained machine-learning model to perform a task.

To begin in this example, a machine-learning system collects training data (block 1102) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1104) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1106). Initialization of the machine-learning model includes selecting a model architecture (block 1108) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1110). The loss function is utilized to measure a difference between an output of the machine-learning model (i.e., predictions) and target values (e.g., as expressed by the training data) to be used to train the machine-learning model. Additionally, an optimization algorithm is selected (1112) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1114) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1118) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1120), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1120), the procedure 1100 continues training of the machine-learning model using the training data (block 1118) in this example.

If the stopping criterion is met (“yes” from decision block 1120), the trained machine-learning model is then utilized to generate an output based on subsequent data (block 1122). The trained machine-learning model, for instance, is trained to perform a task as described above and therefore once trained is configured to perform that task based on subsequent data received as an input and processed by the machine-learning model.

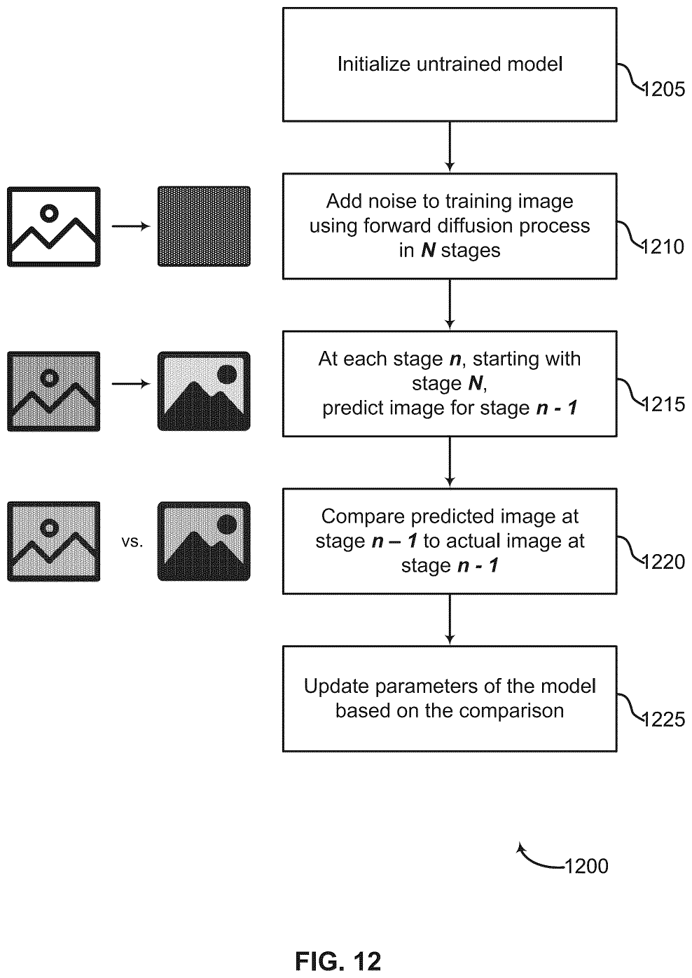

FIG. 12 shows an example of a method 1200 for training a diffusion model according to aspects of the present disclosure. In some embodiments, the method 1200 describes an operation of the training component 240 described for configuring the diffusion prior model 220 or the diffusion model 225 as described with reference to FIG. 2. The method 1200 represents an example for training a reverse diffusion process as described above with reference to FIGS. 3 and 9. In some examples, these operations are performed by a system including a processor executing a set of codes to control functional elements of an apparatus, such as the guided diffusion model described in FIG. 3.

Additionally or alternatively, certain processes of method 1200 may be performed using special-purpose hardware. Generally, these operations are performed according to the methods and processes described in accordance with aspects of the present disclosure. In some cases, the operations described herein are composed of various substeps or are performed in conjunction with other operations.

At operation 1205, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1210, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1215, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1220, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1225, the system updates parameters of the model based on the comparison. For example, parameters of a U-Net may be updated using gradient descent. Time-dependent parameters of the Gaussian transitions can also be learned.

FIG. 13 shows an example of a pipeline for training an image generation apparatus according to aspects of the present disclosure. The example shown includes vectorizable images dataset 1300, text prompt 1305, text encoder 1310, ground truth image 1315, image encoder 1320, diffusion prior model 1325, diffusion model 1330, upsampling model 1335, predicted diffusion output image 1340, predicted upsampled image 1345, and training component 1350.

Text encoder 1310, diffusion prior model 1325, diffusion model 1330, and upsampling model 1330 are examples of, or include aspects of, the corresponding elements described with reference to FIGS. 2 and 5. Training component 1350 is an example of, or includes aspects of, the corresponding element described with reference to FIG. 2.

In the example shown, training component 1350 updates parameters of diffusion prior model 1325, diffusion model 1330, and upsampling model 1335 in a training phase. In at least some embodiments, multiple training phases are performed to update parameters of some components while holding parameters of other components fixed.

To train the diffusion prior model 1325, the system first obtains text prompt 1305, which describes the contents of ground truth image 1315, from vectorizable images dataset 1300. The text prompt may be augmented using prompt engineering terms such as “vector,” “vector style,” and the like. The text prompt 1305 is then encoded using text encoder 1310 (which may be pretrained) to obtain a text embedding, which is passed as input to diffusion prior model 1325. The diffusion prior model 1325 performs a reverse diffusion process to obtain a predicted image embedding using the text embedding as conditioning. The system encodes ground truth image 1315 using image encoder 1320 (which may be pretrained) to obtain a ground truth image embedding. Training component 1350 then compares the predicted image embedding to the ground truth image embedding, and updates parameters of parameters of diffusion prior model 1325 based on the comparison. In this way, diffusion prior model 1325 is trained to transform text embeddings into image embedding priors that confer vector style characteristics during the generation of vectorizable images by the diffusion model 1330. Additional detail regarding training diffusion-based models is provided with reference to FIG. 12.

Diffusion model 1330 is finetuned using vectorizable images from vectorizable images dataset 1300. Diffusion model 1330 may be based on, for example, a large scale pre-trained diffusion model. FIG. 13 illustrates a finetuning process in which diffusion model 1330 is exposed to additional training data including vectorizable images. Additional detail regarding training diffusion-based models is provided with reference to FIG. 12.

To train upsampling model 1335, the system may use the output of diffusion model 1330 or a downsampled version of ground truth image 1315 as input to upsampling model ground truth image 1335. Then, upsampling model 1335 upsamples this input to generate predicted upsampled image 1345. The predicted upsampled image 1345 is compared to ground truth image 1315 using the upsampling model discriminator network 1355 of training component 1350. The upsampling model discriminator network 1355 makes a prediction as to which of the inputs is the ground-truth image and which is the “fake” image, i.e., the predicted upsampled image. The results of this comparison are used to simultaneously update parameters of upsampling model discriminator network 1355 to make better predictions, and to update parameters of upsampling model 1335 to generate better upsampled images. According to some aspects, by exposing upsampling model 1335 to only highly-vectorizable training images, upsampling model 1335 learns to upsample images in a way that encourages vectorizable characteristics.

FIG. 14 shows an example of a method 1400 for tuning an image generation model to generate synthetic vectorizable images according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

“Tuning” (sometimes referred to as “finetuning” herein) describes a process in which parameters of a pre-trained model are adjusted for a particular task. While the pretraining process involves exposing the model to a broad dataset to learn general features, tuning refines the model's parameters to better suit a specific application. For example, in the case of generating synthetic vectorizable images, tuning adjusts the model's parameters to produce outputs that have vectorizable characteristics, such as relatively lower high-frequency detail. The tuning process may include repeated optimizations, where the model's outputs are compared to reference images, and the model parameters are updated to minimize differences in characteristics like such high-frequency detail and harsh contours.

At operation 1405, the system obtains training data including a vectorizable image and a caption describing the vectorizable image. In some cases, the operations of this step refer to, or may be performed by, a vector image generation apparatus as described with reference to FIGS. 1 and 2. The training data may be stored in a database as described with reference to FIG. 1, and transferred to the memory of the vector image generation apparatus. Characteristics of vectorizable images may include, but are not limited to, flat or solid color regions, clearly defined shapes or boundaries, and the absence of gradient transitions or fuzzy edges.

At operation 1410, the system generates a predicted image with a first level of high frequency detail. The operations of this step refer to, or may be performed by, the image generation apparatus as described with reference to FIGS. 2-3. For example, the image generation model may perform a reverse diffusion process as described with reference to FIG. 3 to generate the predicted image.

At operation 1410, the system tunes, using the training data and the predicted image, the image generation model to generate a synthetic vectorizable image based on the caption, wherein the synthetic vectorizable image has a second level of high-frequency detail that is lower than the first level of high frequency detail of the predicted image. The operations of this step refer to, or may be performed by, a training component as described with reference to FIG. 2. For example, the system may update parameters of a pre-trained image generation model by performing a diffusion training process as described with reference to FIG. 12.

In some embodiments, the tuning process further includes updating parameters of a diffusion prior model to generate a diffusion prior embedding that encodes vectorizable characteristics. The training data may include a ground-truth image embedding of the vectorizable image, and the tuning process may iteratively update parameters of the diffusion prior model to learn to translate a text embedding of the caption into the diffusion prior embedding. This tuning process may be performed simultaneously with, or separately from, the tuning of the image generation model. In some examples, the diffusion prior embedding features are used as conditional guidance during the training and inference phases of the image generation model.

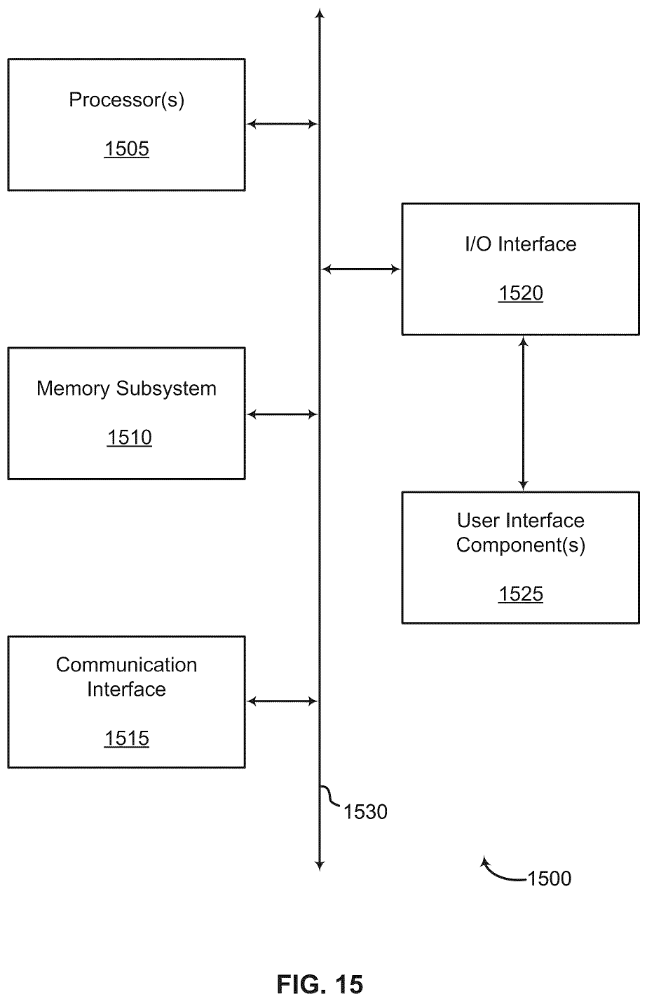

FIG. 15 shows an example of a computing device 1500 according to aspects of the present disclosure. The example shown includes computing device 1500, processor(s) 1505, memory subsystem 1510, communication interface 1515, I/O interface 1520, user interface component(s), and channel 1530.

In some embodiments, computing device 1500 is an example of, or includes aspects of, a vector image generation apparatus as described in FIGS. 1 and 2. In some embodiments, computing device 1500 includes one or more processors 1505 are configured to execute instructions stored in memory subsystem 1510 to obtain a text prompt describing an image element; generate, using an image generation model, a vectorizable image based on the text prompt, wherein the image generation model is trained to reduce high-frequency details; and generate a vector image based on the vectorizable image, wherein the vector image includes the image element described by the text prompt.

According to some aspects, computing device 1500 includes one or more processors 1505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1515 operates at a boundary between communicating entities (such as computing device 1500, one or more user devices, a cloud, and one or more databases) and channel 1530 and can record and process communications. In some cases, communication interface 1515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1520 is controlled by an I/O controller to manage input and output signals for computing device 1500. In some cases, I/O interface 1520 manages peripherals not integrated into computing device 1500. In some cases, I/O interface 1520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1520 or via hardware components controlled by the I/O controller.

According to some aspects, user interface component(s) 1525 enable a user to interact with computing device 1500. In some cases, user interface component(s) 1525 include an audio device, such as an external speaker system, an external display device such as a display screen, an input device (e.g., a remote-control device interfaced with a user interface directly or through the I/O controller), or a combination thereof. In some cases, user interface component(s) 1525 include a GUI.

Accordingly, the present disclosure includes the following aspects.

A method for image generation is described. One or more aspects of the method include obtaining a text prompt describing an image element; generating, using an image generation model, a vectorizable image based on the text prompt, wherein the image generation model is trained to reduce high-frequency details; and generating a vector image based on the vectorizable image, wherein the vector image includes the image element described by the text prompt.

Some examples of the method, apparatus, non-transitory computer readable medium, and system further include encoding the text prompt to obtain a text embedding. Some examples further include converting the text embedding to a diffusion prior embedding. Some examples further include performing a reverse diffusion process based on the diffusion prior embedding to obtain the vectorizable image.

Some examples of the method, apparatus, non-transitory computer readable medium, and system further include upsampling the vectorizable image to obtain an upsampled image, wherein the vector image is based on the upsampled image. In some aspects, the upsampling removes an artifact that interferes with vectorization.

Some examples of the method, apparatus, non-transitory computer readable medium, and system further include obtaining an initial prompt from a user. Some examples further include modifying the initial prompt based on a vector image category to obtain the text prompt. In some aspects, the text prompt includes the vector image category. Some examples further include obtaining a category selection input via a user interface, wherein the vector image category is based on the category selection input.

A method for image generation is described. One or more aspects of the method include obtaining training data including a vectorizable image and training, using the training data, an image generation model to generate vectorizable images with reduced high-frequency detail.

Some examples of the method, apparatus, non-transitory computer readable medium, and system further include obtaining a set of vectorizable images. Some examples further include filtering the set of vectorizable images based on an aesthetic parameter to obtain the training data. In some aspects, the training data includes a caption corresponding to the vectorizable image. Some examples further include obtaining a pre-trained image generation model. Some examples further include tuning the pre-trained image generation model based on the training data.

Some examples of the method, apparatus, non-transitory computer readable medium, and system further include training a diffusion prior model based on the training data. Some examples further include training a diffusion model based on the training data. Some examples further include training an upsampling model based on the training data.

An apparatus for image generation is described. One or more aspects of the apparatus include at least one processor; at least one memory storing instructions executable by the at least one processor; and an image generation model comprising parameters stored in the at least one memory, wherein the image generation model is trained to generate vectorizable images with reduced high-frequency detail using a training set comprising a vectorizable image.

Some examples of the apparatus, system, and method further include a text encoder comprising a transformer architecture. In some aspects, the image generation model comprises a diffusion prior model. In some aspects, the image generation model comprises a diffusion model. In some aspects, the image generation model comprises an upsampling model. Some examples further include a vectorization component configured to transform pixel data to vector data.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method of training a machine learning model, the method comprising:
obtaining training data including a vectorizable image and a caption describing the vectorizable image;
generating, using an image generation model, a predicted image with a first level of high frequency detail; and
tuning, using the training data and the predicted image, the image generation model to generate a synthetic vectorizable image based on the caption, wherein the synthetic vectorizable image has a second level of high frequency detail that is lower than the first level of high frequency detail of the predicted image.

2. The method of claim 1, wherein obtaining the training data comprises:
obtaining a set of vectorizable images; and
filtering the set of vectorizable images based on an aesthetic parameter to obtain the training data.

3. The method of claim 1, wherein obtaining the training data comprises:
obtaining a preliminary caption including the description of the vectorizable image; and
appending a description of a vectorizable image category to the preliminary caption to obtain the caption.

4. The method of claim 1, wherein tuning the image generation model comprises:
obtaining a pre-trained image generation model; and
training the pre-trained image generation model to generate vectorizable images using on the training data.

5. The method of claim 1, wherein tuning the image generation model comprises:
computing a diffusion loss based on the vectorizable image; and
updating parameters of the image generation model based on the diffusion loss.

6. The method of claim 1, further comprising:
tuning an upsampling model based on the training data.

7. The method of claim 1, wherein the second level of high frequency detail corresponds to a level of high frequency detail in the vectorizable image.

8. A non-transitory computer readable medium storing code for image processing, the code comprising instructions that, when executed by at least one processor, causes the at least one processor to perform operations comprising:
obtaining a text prompt describing an image element;
generating, using an image generation model, a vectorizable image based on the text prompt, wherein the image generation model is trained to reduce high-frequency details; and
generating a vector image based on the vectorizable image, wherein the vector image includes the image element described by the text prompt.

9. The non-transitory computer readable medium of claim 8, wherein generating the vectorizable image comprises:
encoding the text prompt to obtain a text embedding;
converting the text embedding to a diffusion prior embedding; and
performing a reverse diffusion process based on the diffusion prior embedding to obtain the vectorizable image.

10. The non-transitory computer readable medium of claim 8, wherein generating the vectorizable image comprises:
upsampling the vectorizable image to obtain an upsampled image, wherein the vector image is based on the upsampled image.

11. The non-transitory computer readable medium of claim 10, wherein:
the upsampling removes an artifact that interferes with vectorization.

12. The non-transitory computer readable medium of claim 8, wherein:
the text prompt includes a vector image category.

13. The non-transitory computer readable medium of claim 8, wherein obtaining the text prompt comprises:
obtaining an initial prompt from a user; and
modifying the initial prompt based on a vector image category to obtain the text prompt.

14. The non-transitory computer readable medium of claim 13, wherein obtaining the text prompt further comprises:
obtaining a category selection input via a user interface, wherein the vector image category is based on the category selection input.

15. A system comprising:
a memory component; and
a processing device coupled to the memory component, the processing device configured to perform operations comprising:
obtaining a text prompt describing an image element;
generating, using an image generation model, a vectorizable image based on the text prompt, wherein the image generation model is trained to reduce high-frequency details; and
generating a vector image based on the vectorizable image, wherein the vector image includes the image element described by the text prompt.

16. The system of claim 15, further comprising:
a text encoder comprising a transformer architecture.

17. The system of claim 15, wherein:
the image generation model comprises a diffusion model.

18. The system of claim 15, wherein:
the image generation model comprises a diffusion prior model.

19. The system of claim 15, wherein:
the image generation model comprises an upsampling model.

20. The system of claim 15, further comprising:
a vectorization component configured to transform pixel data to vector data.
